(19) United States
(12) Patent Application Publication
(10) Pub. No.: US 2010/0158172 A1
(43) Pub. Date: Jun. 24, 2010

(54) DIGITAL DIRECT CONVERSION RECEIVER BASED ON VARIABLE DELAY AND CONSTANT INTERPOLANT FOR RECEIVING RADIO FREQUENCY SIGNAL AND METHOD THEREOF

(76) Inventors: Hyung Jung KIM, Daejeon (KR); Jae Hyung KIM, Gyeongsangnam-do (KR)

Correspondence Address: LADAS & PARRY LLP, 224 SOUTH MICHIGAN AVENUE, SUITE 1600, CHICAGO, IL, 60604, US

(21) Appl. No.: 12/555,225

(22) Filed: Sep. 8, 2009

(30) Foreign Application Priority Data
Dec. 19, 2008 (KR) 10-2008-0130309

(51) Int. Cl. H04B 1/10

(52) U.S. Cl. 375/346

(57) ABSTRACT

Disclosed is a digital direct conversion receiver including a clock generation and a distribution unit to generate a clock signal having a time difference that generates a predetermined phase difference, a Track & Holder (T&H) to perform sampling of a radio frequency (RF) signal selected by a tunable RF filter with a selected sampling frequency and down converting of the sampled signal, and to generate the predetermined phase difference between sampled signals by using the clock signal having the time difference during the down-conversion, an analog-digital (AD) converter to generate a sample stream having phase difference information from the down-converted sampled signal, and a complex interpolant to eliminate an image component from the sample stream using a phase difference between a plurality of sample streams.

### CROSS-REFERENCE TO RELATED APPLICATION

This application claims the benefit of Korean Patent Application No. 10-2008-0130309, filed on Dec. 19, 2008, in the Korean Intellectual Property Office, the disclosure of which is incorporated herein by reference.

### BACKGROUND

1. Field of the Invention

Example embodiments relate to a digital direct conversion receiver and a method thereof that performs sampling of a radio frequency (RF) signal selected by a tunable RF filter with a selected sampling frequency and down converting of the sampled signal, generates a predetermined phase difference between sampled signals where a clock signal is used, using the clock signal capable of adjusting a time difference, and eliminates an image component from a sample stream by using the phase difference between a plurality of sample streams.

2. Description of the Related Art

When a Radio Frequency (RF) signal which is an analog signal is received, a sampling frequency which is at least twice a carrier frequency is required to enable an existing sampling theory to be applied. In general, however, a bandwidth where a signal exists may be 0.003 to 0.2% of a carrier frequency. Accordingly, a sampling scheme based on a carrier frequency may be ineffective and affect a digital domain due to a significant amount of data.

However, a band-pass sampling (BPS) scheme where the sampling frequency is determined based on a bandwidth of a signal without depending on the carrier frequency, may allow an effective system to be designed. As described above, a technology that processes an input signal as a digital and uses a narrow bandwidth is referred to as a digital direct conversion scheme or an RF direct conversion scheme. In terms of an algorithm, the technology may also be referred to as a BPS, a harmonic sampling, or a sub-sampling. A digital direct conversion scheme, which apply a lower sampling frequency for intentionally generating aliasing, basically have an advantage of having a sample rate based on a bandwidth of information.

The digital direct conversion scheme or the RF direct conversion scheme is a structure of a receiver based on a theory that an analog down-converting function is replaceable with a sampling, and performs sampling of a signal received through an antenna directly after passing a low noise amplifier (LNA), and thus, a chip and small wireless receiver may be embodied.

FIG. 1 is a diagram illustrating a configuration of a 1^{st}-order digital direct conversion receiver according to a conventional art.

As illustrated in FIG. 1, the 1^{st}-order digital direct conversion receiver receives an RF signal through an antenna, eliminates a noise of a desired RF signal using a pre-selector and an LNA, only passes a desired frequency band of the RF signal through an RF band-pass filter (BPF), performs sampling and down-converting of the selected RF signal using a mixer and an analog-digital converter (ADC), eliminates an undesired frequency component of the down-converted signal using an LPF, and extracts a desired signal through a digital signal processor (DSP).

However, a 1^{st}-order digital direct conversion receiver may perform down-conversion of an integer-position signal with a minimum sample rate (fₛ=2 B) twice a sample rate of a bandwidth (B), and may perform down-conversion of a non-integer position signal with a minimum sample rate (fₛ>2 B) greater than twice the sample rate of the bandwidth. However, the sampling frequency (fₛ) varies according to a location of a signal band, and the sample rate is required to be changed according to the bandwidth and a location of a band to perform universal access, and thus, there is a difficulty that a bandwidth of an RF filter is required to be varied.

Accordingly, in order to overcome the above-described disadvantages, a 2^{nd}-order digital direct conversion receiver is used instead of the 1^{st}-order digital direct conversion receiver.

FIG. 2 is a diagram illustrating a configuration of a 2^{nd}-order digital direct conversion receiver according to a conventional art.

As illustrated in FIG. 2, the 2^{nd}-order digital direct conversion receiver performs sampling an RF signal selected by a tunable RF filter with a sampling frequency selected by a Track & Holder (T & H) and down-converting of the sampled signal, generates a down-converted sampled signal having phase difference information using a clock signal generated from a clock generation and distribution unit, and eliminates an image component from input streams by an interpolant using a phase difference between the input streams.

The 2^{nd}-order digital direct conversion receiver uses a scheme that performs sampling of a signal to have a relative time delay, using the T&H having two paths and two ADCs, and eliminates aliasing using a signal process. Accordingly, the sample rate is selected without considering the aliasing, and the minimum sampling frequency having the same frequency as a bandwidth of the signal may be selected.

However, the interpolant is required to perform sampling of S_{B}(t) with a sample rate B since a sample rate of an input stream is B, and when S_{B}(t) is sampled with a sample rate B, aliasing may occur since the bandwidth of S_{B}(t) is B. Therefore, the 2^{nd}-order digital direct conversion receiver has a weak point that the 2^{nd}-order digital direct conversion receiver only operates under integer positions, and always reconstructs the interpolant according to a location of a band.

### SUMMARY

An aspect of the present invention may provide a digital direct conversion receiver and a method thereof that may reconstruct a minimum signal process algorithm without changing hardware of the digital direct conversion receiver when a signal in a Radio Frequency (RF) band is down-converted, thereby enabling universal access.

Another aspect of the present invention may provide a digital direct conversion receiver and a method thereof that may operate in any condition regardless of an integer position signal and a non-integer position signal.

Another aspect of the present invention may provide a digital direct conversion receiver and a method thereof that may set an adjustable time difference in a clock signal generated from a clock generation and distribution unit to generate a predetermined phase difference between sample streams, thereby directly performing digital direct conversion using a constant interpolant.

Another aspect of the present invention may provide a digital direct conversion receiver and a method thereof that may reuse multiple interpolant sets, even when a clock signal generated from a clock generation and distribution unit has a limited value.

According to an aspect of the present invention, there may be provided a digital direct conversion receiver including a clock generation and distribution unit to generate a clock signal having a time difference that generates a predetermined phase difference, a Track & Holder (T&H) to perform sampling and down-converting of an RF signal selected from a tunable RF filter with a selected sampling frequency, and to generate predetermined phase difference information between the sampled signals by using the clock signal having the time difference during the down-conversion, an analog-digital (AD) converter to generate a sample stream having phase difference information from the down-converted sampled signal, and a complex interpolant to eliminate an image component from the sample stream using phase difference between a plurality of sample streams.

According to an aspect of the present invention, there is provided a method of providing a digital direct conversion, including generating a clock signal having a time difference that generates a predetermined phase difference information between sampled signals while a selected RF signal is processed, performing sampling and down-converting of the selected RF signal with a selected sampling frequency using the clock signal, and eliminating an image component from a sample stream using a phase difference between a plurality of sample streams where the clock signal used.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a 1^{st}-order digital direct conversion receiver according to a conventional art;

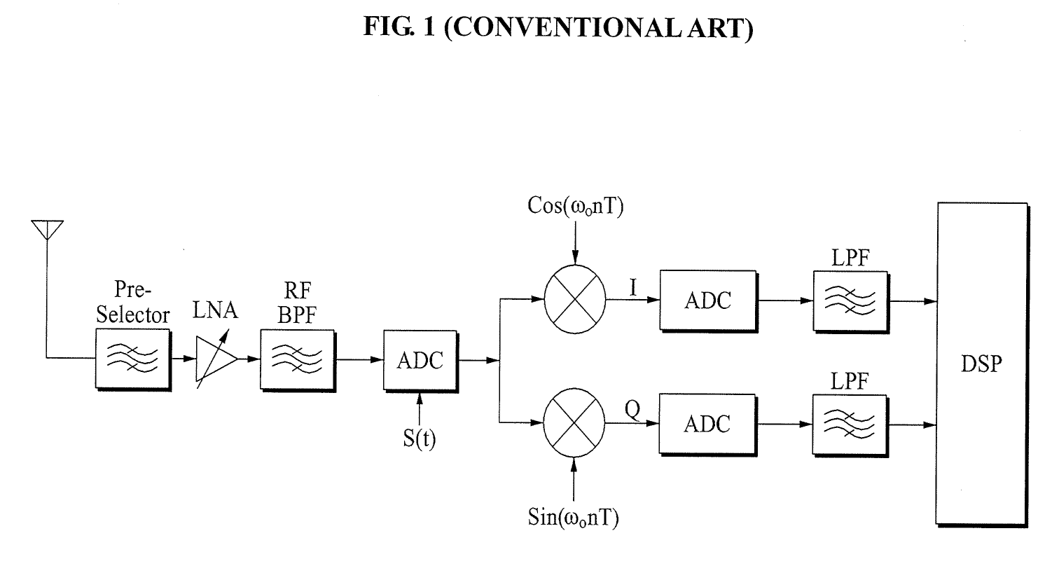

FIG. 2 is a diagram illustrating a configuration of a 2^{nd}-order digital direct conversion receiver according to a conventional art;

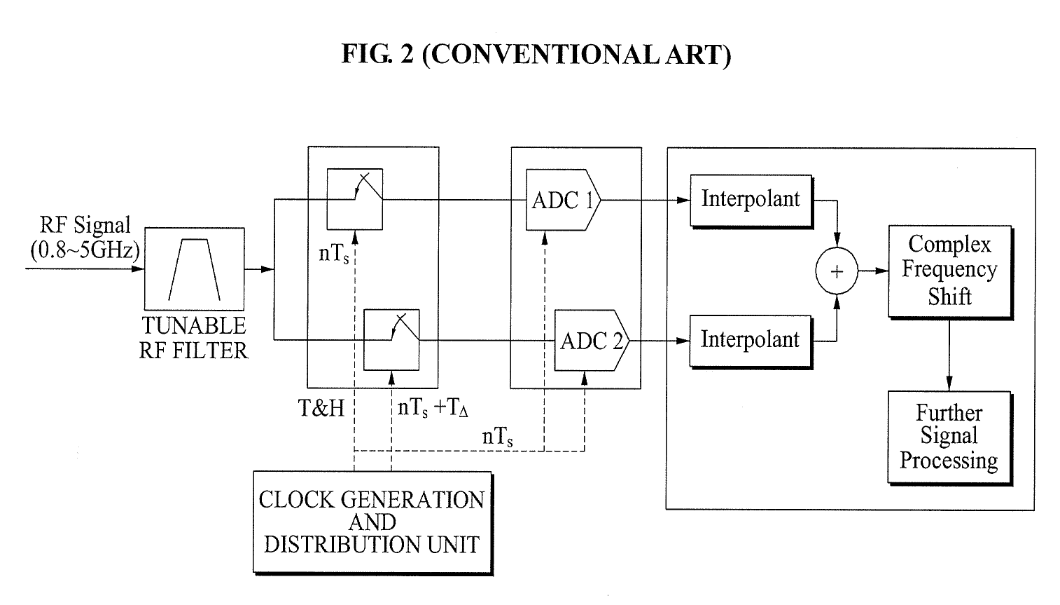

FIG. 3 is a diagram illustrating a configuration of a digital direct conversion receiver according to an embodiment of the present invention;

FIG. 4 is a diagram illustrating an example of an RF signal having a same phase delay according to an embodiment of the present invention;

FIG. 5 is a diagram illustrating an example of sample streams where a phase difference occurs according to an embodiment of the present invention; and

FIG. 6 is a diagram illustrating an example of eliminating an image component of a sample stream using a complex interpolant according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

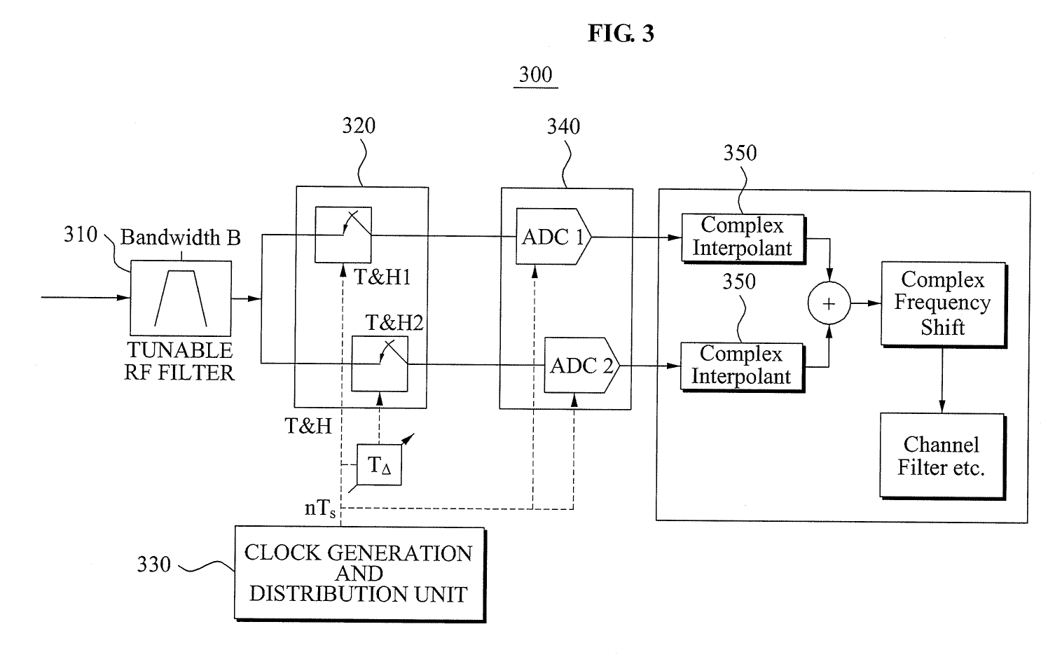

FIG. 3 is a diagram illustrating a configuration of a digital direct conversion receiver 300 according to an embodiment of the present invention.

The digital direct conversion receiver 300 may include a clock generation and distribution unit 330 to generate a clock signal having a time difference that generates a predetermine phase difference, a Track & Holder (T&H) 320 to perform sampling of an RF signal selected by a tunable RF filter 310 with a selected sampling frequency and down-converting of the sampled signal, and to generate predetermined phase difference information between the sampled signals using the clock signal having the time difference during the down-conversion, an analog-digital (AD) converter 340 to generate a sample stream having phase difference information from the down-converted sampled signal, and a complex interpolant 350 to eliminate an image component from the sample stream using phase difference information between a plurality of sample streams.

Here, the digital direct conversion receiver 300 may adopt a 2^{nd}-order digital direct conversion receiver scheme.

The tunable RF filter 310 may select an RF signal to be down-converted, from among RF signals received through an antenna, and may eliminate a noise and aliasing of the selected RF signal. That is, the tunable RF filter 310 may perform as a low noise amplifier (LNA) and a band-pass filter (BPF).

The T&H 320 may perform sampling of the selected RF signal with a selected sampling frequency and down-converting of the sampled signal. That is, the T&H 320 may perform sub-sampling of the selected RF signal with a 2 B sampling frequency using a clock signal having a time difference and down-converting of the sub-sampled signal, the 2 B sampling frequency being twice a frequency of a bandwidth.

The AD converter 340 may generate a sample stream having phase difference information from the down-converted sampled signal, and may transmit the generated sample stream to the complex interpolant 350. Here, the AD converter 340 performs as a quantizer, and basically operates at a 2 B sample rate. Accordingly, only an n^{th} reproduction component from among spectrum reproduction components generated by sampling appears in a baseband, −B<f<B, and thus, a same interpolant is repeatedly used.

Two T&H1 and T&H2 320 insert a clock signal having a relative time difference of T_{Δ}, for generating a phase difference between two sample signals having time difference of T_{Δ}. Because a scheme that varies T_{Δ} according to a Nyquist area where a signal band is placed for setting a predetermined phase difference may be used to repeatedly use the same interpolant when an image is eliminated from a signal down-converted from different bands.

The digital direct conversion receiver 300 performs down-converting of an RF signal placed in a band and eliminates an image component without a limitation that a relation between a bandwidth and a carrier frequency needs to be an integer position. To achieve the above, the digital direct conversion receiver 300 arranges the down-converted signal in an intermediate frequency band that is close to 0 Hz, to avoid an affect from a DC offset and the like, and enables a baseband signal to be reproduced by the complex interpolant 350, a channel filter, and a digital up/down converter.

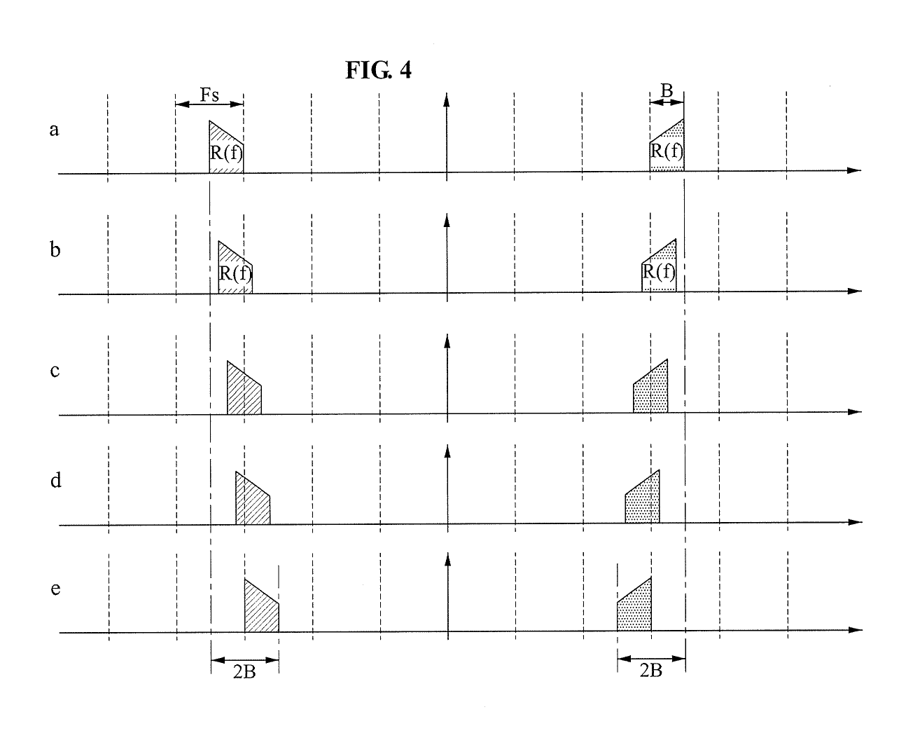

FIG. 4 is a diagram illustrating an example of an RF signal having a same phase delay according to an embodiment of the present invention.

FIG. 4 illustrates an example that the tunable RF filter 310 selects signals placed in a band of (n−½)fₛ<f<(n+½)fₛ. When the signals placed in the band is sampled with f_{S}=2 B, a positive frequency component, namely, P=n^{th} spectrum of R_{A+}^{δ2}(f), R_{B+}^{δ2}(f) appears in a baseband, −B<f<B and a negative frequency component, namely, P=−n^{th} spectrum of R_{A-}^{δ2}(f), R_{B-}^{δ2}(f) appears in the baseband, −B<f<B. In this instance, a phase shift of φₙ=−2πhT_{Δ}f_{S}=−2πnT_{Δ}(2 B) occurs in a sample stream B, and RF signals having a same n value also have a same phase shift. Accordingly, the signals in the band of (n−½)f_{S}<f<(n+½)f_{S} may eliminate an image using a same interpolant.

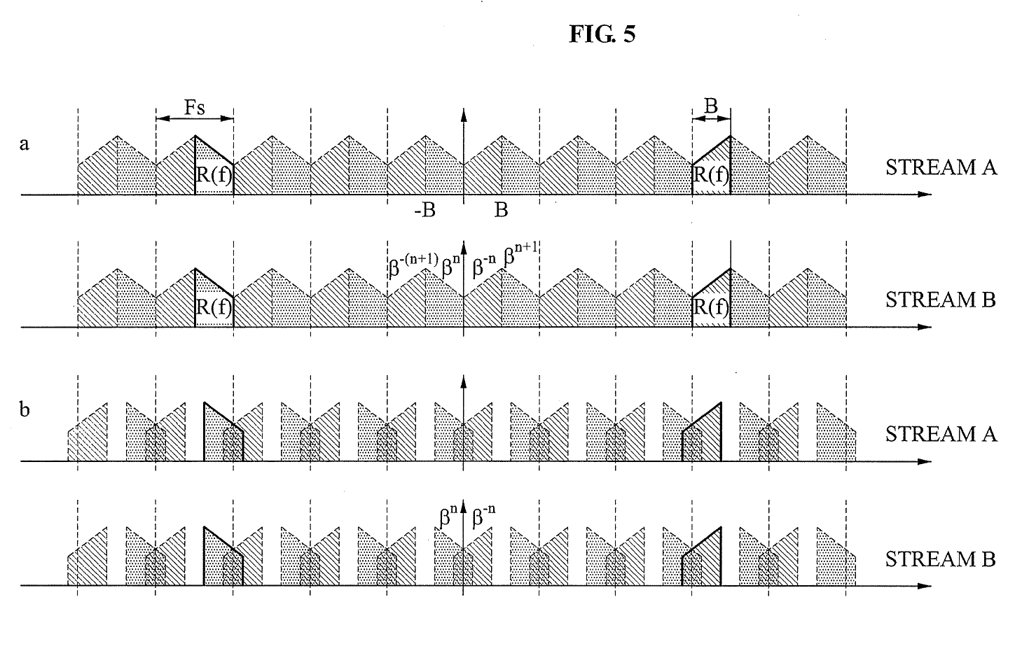

FIG. 5 is a diagram illustrating an example of sample streams where a phase difference occurs according to an embodiment of the present invention.

FIG. 5 illustrates two AD converter output spectrums that are sampled with f_{S}=2 B, when RF spectrums are placed as given in output a and output b of FIG. 4. A sample stream B has a relative phase delay with respect to a sample stream A, and the value is different according to a Nyquist zone where an RF signal is placed. A bandwidth of a signal in a band of (n−½)f_{S}<f<(n+½)f_{S} is limited to B, a phase shift of φₙ=−2πnT_{Δ}(2 B) always occurs in a baseband of the sample stream B, where −B<f<B. The complex interpolant 350 may shift a phase of the sample stream B, R_{B}^{δ2}(f), by −β⁻ⁿ, and may be added to the sample stream A, thereby eliminating an image component that is an aliasing component from a negative frequency band.

According to an embodiment of the present invention, the clock generation and distribution unit 330 generates a clock signal having a time difference and insert the clock signal to the T&H 320 and to the AD converter 340. That is, the clock generation and distribution unit 330 generates a first clock signal and a second signal, both having different time differences, and inserts the first clock signal and the second signal to the T&H 320. The T&H 320 generates a phase difference between a first sample signal and a second sample signal where the first clock signal and the second clock signal are respectively inserted. The AD converter 340 generates a first sample stream and a second sample stream from a down-converted sampled signal, using the first signal or the second clock signal. Here, the first sample stream may be the sample stream A and the second sample stream may be the sample stream B.

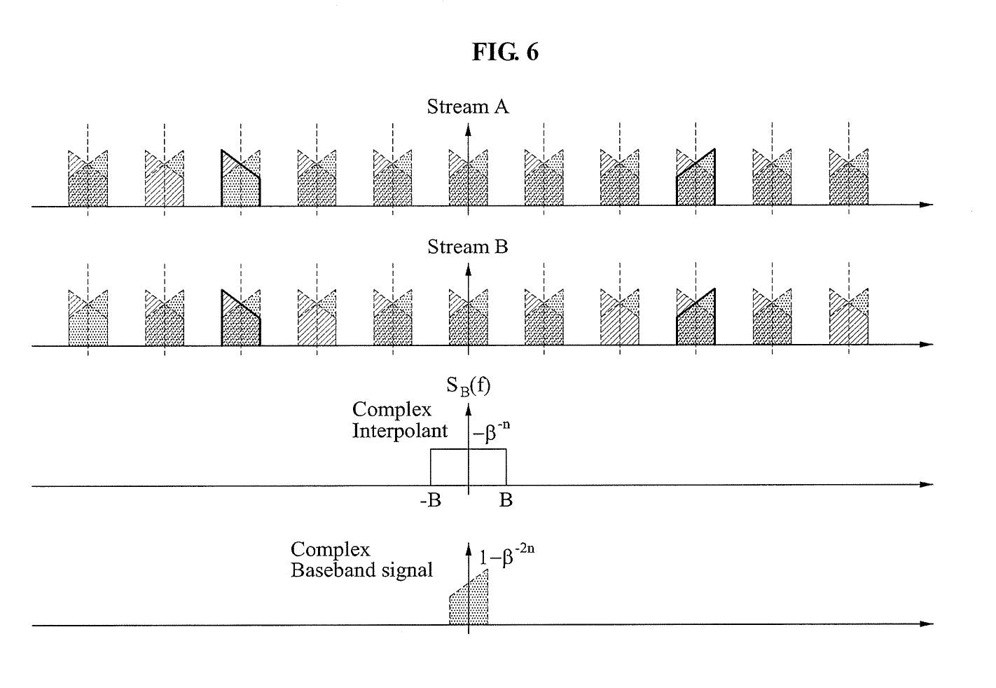

FIG. 6 is a diagram illustrating an example of eliminating an image component of a sample stream using a complex interpolant according to an embodiment of the present invention.

FIG. 6 illustrates that a spectrum appears when a signal placed as given in output e of FIG. 4 is sampled with a sample frequency of f_{S}=2 B. When S_{A}(f) and S_{B}(f) are applied to the complex interpolant 350 to eliminate a negative frequency image component, the following output is obtained.

R^{δ2}(f)=S_{A}(f)·R_{A}^{σ2}(f)+S_{B}(f)·R_{B}^{σ2}(f) [Equation 1]

Here, R^{δ2}(f) is a frequency spectrum of a base-pass sampled RF signal according to a 2^{nd}-order. R_{A}^{δ2}(f) is a frequency spectrum of a sample stream A and R_{B}^{δ2}(f) is a frequency spectrum of a sample stream B.

To eliminate the image component, namely, a negative frequency component, Equation 1 may be given again as Equation 2.

B·[S_{A}(f)·R_{A+}^{δ2}(f)+S_{B}(f)·R_{B+}^{δ2}(f)]=C·R_{A+}(f−2 nB)

B·[S_{A}(f)·R_{A-}^{δ2}(f)+S_{B}(f)·R_{B-}^{δ2} (f)]=0 [Equation 2]

Here, B is a signal-bandwidth of an RF signal, C is a complex constant, and R_{A+}^{δ2}(f−2 nB) is a positive frequency spectrum of an RF signal shifted to a baseband.

To solve Equation 2, S_{A}(f) is selected as given in Equation 3.

$${S}_{A} ( f ) = \{ \begin{matrix}1 / B & \vert f \vert < B \\ 0 & otherwise\end{matrix} \qquad [ Equation 3 ]$$

Also, when Equation 3 is substituted to Equation 2 in a condition of |f|<B, the below Equation 4 is required to be satisfied to eliminate the image component.

R_{A+}^{δ2}(f)+B·S_{B}(f)·R_{B+}^{δ2}(f)=C·R_{A+}(f−2 nB)

R_{A-}^{δ2}(f)+B·S_{B}(f)·R_{B-}^{δ2}(f)=0 [Equation 2]

Therefore, S_{B}(f) is given as Equation 5.

$${S}_{B} ( f ) = \{ \begin{matrix}\frac{- {β}^{- n}}{B} & \vert f \vert < B \\ 0 & otherwise\end{matrix} \qquad [ Equation 5 ]$$

Here, β=e^{-j2πT}^{_{Δ}}^{f}^{_{S}}=e^{-j2πT}^{_{Δ}}^{(2B)} is a phase difference between the sample stream A and the sample stream B.

That is, a bandwidth of S_{B}(f) is B as a maximum, and thus, there is no difficulty in embodying a digital interpolant by sampling an impulse response with f_{S}=2 B. However, since the digital interpolant is required to be embodied as the complex interpolant 350, a baseband signal where the image component is eliminated is also required to be a complex signal.

According to another embodiment of the present invention, the digital direct conversion receiver 300 may eliminate the image using the complex interpolant 350 having a frequency response of S_{B}(f)=−β⁻ⁿ=−e^{-j2πnT}^{_{Δ}}^{f}^{_{S}}, when a bandwidth of RF signals in (n−½)f_{S}<|f|<(n+½)f_{S} is limited to B and the RF signals are sampled with a sample rate of f_{S}=2 B However, when the RF signals are respectively placed in areas having different n_{S}, the interpolant is required to be reconstructed. However, when maintaining nT_{Δ}f_{S} fit to be constant is possible by adjusting T_{Δ} or f_{S}, a same interpolant may be used in all bands. That is, the digital direct conversion receiver 300 may reuse several interpolant sets, even when T_{Δ} has a random value or T_{Δ} has limited value.

Also, the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

According to the present invention, the digital direct conversion receiver may reconstruct a minimum signal process algorithm without changing hardware of the digital direct conversion receiver when a signal in an RF band is down converted, thereby enabling universal access.

Also, according to the present invention, the digital direct conversion receiver may directly convert an RF signal in any condition regardless of an integer position signal, a non-integer position signal.

Also, according to the present invention, the digital direct conversion receiver may set a time difference that generates a predetermine phase difference between sample streams, when a clock signal generated from a clock generation and distribution unit is generated, thereby enabling a digital direct conversion using a constant interpolant.

Also, according to the present invention, the digital direct conversion receiver may perform direct digital-conversion by reusing only multiple interpolant sets, even when a clock signal generated from a clock generation and distribution unit has a limited value.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A digital direct conversion receiver, comprising:
a Track & Holder (T&H) to perform sampling of a radio frequency (RF) signal selected by a tunable RF filter with a selected sampling frequency and down converting of the sampled signal, and to generate a predetermined phase difference between sampled signals by using a clock signal having a time difference during the down-conversion and;
an analog-digital (AD) converter to generate a sample stream having phase difference information from the down-converted sampled signal; and
a complex interpolant to eliminate an image component from the sample stream using the phase difference between a plurality of sample streams.

2. The digital direct conversion receiver of claim 1, further comprising:
a clock generation and distribution unit to generate a first clock signal and a second clock signal, both having different time differences,
wherein the complex interpolant eliminates an image component having a negative frequency band by summing up a first sample stream where the first clock signal is inserted and a second sample stream where the second clock signal is inserted.

3. The digital direct conversion receiver of claim 2, wherein the complex interpolant eliminates the image component having the negative frequency band by summing up the second sample stream a phase of which is shifted by −β⁻ⁿ, and the first sample stream.

4. The digital direct conversion receiver of claim 2, wherein the first sample stream and the second stream have a predetermined phase delay regardless of a Nyquist zone where the RF signal is placed.

5. The digital direct conversion receiver of claim 2, wherein the down-converted sampled signal is set to be in an intermediate frequency (IF) band, and the complex interpolant generates the sample stream where the image component is eliminated as a baseband signal.

6. The digital direct conversion receiver of claim 1, wherein the T&H performs sampling of the RF signal with a frequency twice a frequency of a bandwidth.

7. A method of providing a digital direct conversion receiver, comprising:
sampling of a selected RF signal with a selected sampling frequency, down-converting the sampled signal, and inserting a clock signal having a time difference to the down-converted sampled signal during the down-conversion; and
eliminating an image component from a sample stream by using a phase difference between a plurality of sample streams where the clock signal is inserted.

8. The method of claim 7, further comprising:
generating a first clock signal and a second clock signal, both having different time differences,
wherein the eliminating of the sample stream eliminates an image component having a negative frequency band by summing up a first sample stream where the first clock signal is inserted, and a second sample stream where the second clock signal is inserted.

9. The method of claim 8, wherein the eliminating of the image component from the sample stream comprises eliminating the image component having the negative frequency band by summing the second sample stream a phase of which is shifted by −β⁻ⁿ, and the first sample stream.

10. The method of claim 7, further comprising:
generating the sample stream where the image component is eliminated as a baseband signal.
